(19) United States
(12) Patent Application Publication
(10) Pub. No.: US 2018/0202584 A1
(43) Pub. Date: Jul. 19, 2018

(54) Rubber Composition for Flame-Retardant Hose, and Flame-Retardant Hose

(71) Applicant: The Yokohama Rubber Co., LTD., Minato-ku, Tokyo (JP)

(72) Inventor: Aya Sato, Hiratsuka-shi, Kanagawa (JP)

(21) Appl. No.: 15/743,265

(22) PCT Filed: Jun. 28, 2016
(86) PCT No.: PCT/JP2016/069104

§ 371 Date: Jan. 9, 2018

(30) Foreign Application Priority Data
Jul. 13, 2015 (JP) 2015-139780

(51) Int. Cl. F16L 11/12; C08K 3/016; C08K 3/36; C08K 3/04; C08L 11/00; C08L 9/06

(52) U.S. Cl. CPC F16L 11/125; C08K 3/016; C08K 3/36; C08K 2003/2227; C08L 11/00; C08L 9/06; C08L 2201/02; C08K 3/04

(57) ABSTRACT

Provided are a rubber composition for a flame-retardant hose, the rubber composition including from 20 to 45 parts by mass of aluminum hydroxide and greater than 65 parts by mass of a carbon black per 100 parts by mass of a rubber component containing at least chloroprene rubber, and the flame-retardant hose including a rubber layer formed using the rubber composition for a flame-retardant hose.

### TECHNICAL FIELD

The present technology relates to a rubber composition for a flame-retardant hose and a flame-retardant hose.

### BACKGROUND ART

Conventionally, hoses having a rubber layer formed using a rubber composition having flame retardancy have been proposed.

For example, Japanese Unexamined Patent Application Publication No. 2013-129684 discloses a rubber composition for a hose including chloroprene rubber, butadiene rubber, and styrene-butadiene rubber as rubber components, from 60 to 80 parts by mass of the chloroprene rubber, and from 5 to 25 parts by mass of silica per 100 parts by mass of the rubber components.

When the present inventors prepared and evaluated rubber compositions containing chloroprene rubber and the like based on Japanese Unexamined Patent Application Publication No. 2013-129684, they found that such rubber compositions sometimes have low flame retardancy. Furthermore, they found that rupture properties and wear resistance are sometimes low.

### SUMMARY

The present technology provides a rubber composition for a flame-retardant hose having excellent flame retardancy, rupture properties, and wear resistance.

The present technology provides a flame-retardant hose.

The present inventors discovered that a predetermined effect is obtained due to a rubber composition containing aluminum hydroxide and carbon black in specific amounts relative to rubber components including at least chloroprene rubber. The present technology comprises the following configuration.

1. A rubber composition for a flame-retardant hose, the composition including: from 20 to 45 parts by mass of aluminum hydroxide and greater than 65 parts by mass of a carbon black per 100 parts by mass of a rubber component containing at least chloroprene rubber.

2. The rubber composition for a flame-retardant hose according the above 1, wherein the rubber component further includes a diene rubber other than the chloroprene rubber.

3. The rubber composition for a flame-retardant hose according to the above 2, wherein the diene rubber is styrene-butadiene rubber.

4. The rubber composition for a flame-retardant hose according to any one of the above 1 to 3, wherein a content of the chloroprene rubber is not less than 70 parts by mass per 100 parts by mass of the rubber component.

5. The rubber composition for a flame-retardant hose according to any one of the above 1 to 4, wherein a content of the carbon black is from 66 to 90 parts by mass per 100 parts by mass of the rubber component.

6. The rubber composition for a flame-retardant hose according to any one of the above 1 to 5, further including a silica, wherein a content of the silica is from 5 to 25 parts by mass per 100 parts by mass of the rubber component.

7. A flame-retardant hose including a rubber layer formed using the rubber composition for a flame-retardant hose described in any one of the above 1 to 6.

The rubber composition for a flame-retardant hose of the present technology has excellent flame retardancy, rupture properties, and wear resistance.

The flame-retardant hose of the present technology has excellent flame retardancy, rupture properties, and wear resistance.

### BRIEF DESCRIPTION OF DRAWINGS

FIG. 1 is a perspective view illustrating a cutaway of each layer of an example of the flame-retardant hose of the present technology.

FIG. 2 is a perspective view illustrating a cutaway of each layer of another example of the flame-retardant hose of the present technology.

### DETAILED DESCRIPTION

Embodiments of the present technology are described in detail below.

Note that, in the present specification, numerical ranges indicated using “(from) . . . to . . . ” include the former number as the lower limit value and the latter number as the upper limit value.

Furthermore, in the present specification, when a component includes two or more substances, the content of that component indicates the total content of the two or more substances.

In the present technology, in cases where at least one of flame retardancy, rupture properties, and wear resistance is superior, it is stated as “exhibiting superior effect of the present technology”.

### Rubber Composition for Flame-Retardant Hose

The rubber composition for a flame-retardant hose of the present technology (rubber composition of the present technology) includes from 20 to 45 parts by mass of aluminum hydroxide and greater than 65 parts by mass of a carbon black per 100 parts by mass of a rubber component containing at least chloroprene rubber.

The rubber composition of the present technology is thought to achieve the desired effects as a result of having such a configuration. Although the reason for this is unknown, the reason is presumed to be as follows.

It is thought that aluminum hydroxide is subjected to pyrolysis to generate water under high-temperature conditions, that is, undergoes dehydration reaction. It is thought that a flame retardant effect is exhibited due to heat absorption by this dehydration reaction and due to the water generated by the dehydration reaction turning into steam.

Furthermore, it is thought that including aluminum hydroxide and carbon black in amounts within specific ranges in rubber components including chloroprene rubber increases reinforcement action and improves rupture properties and wear resistance.

Each of the components contained in the rubber composition of the present technology will be described in detail below.

### Chloroprene Rubber

The chloroprene rubber (CR) included in the rubber composition of the present technology is not particularly limited. Examples thereof include conventionally known chloroprene rubbers. One type of chloroprene rubber can be used alone or a combination of two or more can be used.

### Rubber Components

The rubber components contained in the rubber composition of the present technology include at least chloroprene rubber.

The rubber components may further include rubbers other than chloroprene rubber. Examples of rubbers other than chloroprene rubber include diene rubbers other than chloroprene rubber, and rubbers other than diene rubbers.

The rubbers other than chloroprene rubber are not particularly limited provided that they are rubbers generally included in rubber compositions. Examples of rubbers other than chloroprene rubber include rubbers other than diene rubbers, such as acrylic rubber (ACM), ethyl acrylate-ethylene copolymer (AEM), ethyl acrylate-acrylonitrile copolymer (ANM), ethylene-propylene-diene terpolymer (EPDM), ethylene-propylene copolymer (EPM), ethylene-vinyl acetate copolymer (EVM), fluororubber (FKM), fully hydrogenated nitrile rubber (NBM), epichlorohydrin rubber (CO), ethylene oxide-epichlorohydrin copolymer (ECO), dimethylsilicone rubber (MQ), polysulfide rubber (OT), and polyester urethane (AU); and diene rubbers other than chloroprene rubber, such as acrylate butadiene rubber (ABR), butadiene rubber (BR), natural rubber (NR), epoxidized natural rubber (ENR), isoprene rubber (IR), acrylonitrile-isoprene rubber (NIR), butyl rubber (IIR), hydrogenated nitrile rubber (HNBR), nitrile rubber (NBR), styrene-butadiene rubber (SBR), styrene-isoprene-butadiene rubber (SIBR), carboxylated butadiene rubber (XBR), carboxylated nitrile rubber (XNBR), carboxylated styrene-butadiene rubber (XSBR), brominated butyl rubber (BIIR), and chlorinated butyl rubber (CIIR).

From the perspective of excellent wear resistance and processability, a preferred diene rubber other than chloroprene rubber is styrene-butadiene rubber.

The styrene-butadiene rubber is not particularly limited. Examples thereof include conventionally known styrene-butadiene rubbers.

The weight average molecular weight of the styrene-butadiene rubber is preferably from 250000 to 1200000, and preferably from 400000 to 600000 from the perspective of exhibiting superior effect of the present technology and excellent wear resistance and processability. In the present technology, the weight average molecular weight of the styrene-butadiene rubber is a value calibrated with polystyrene standard based on a measured value obtained by gel permeation chromatography (GPC) using tetrahydrofuran (THF) as a solvent.

Styrene-butadiene rubber is preferably a styrene-butadiene rubber produced by emulsion polymerization (emulsion polymerized SBR) from the perspectives of being highly versatile, inexpensive, and excellent processability, such as cohesion or roll winding characteristics, of the unvulcanized rubber discharged after being mixed in a Banbury mixer or the like.

The method of emulsion polymerization is not particularly limited. Examples thereof include conventionally known methods.

One type of diene rubber other than chloroprene rubber can be used alone or a combination of two or more types can be used.

The content of chloroprene rubber is preferably from 70 to 100 parts by mass, and more preferably from 80 to 90 parts by mass, per 100 parts by mass of the rubber components from the perspective of exhibiting superior effect of the present technology.

### Aluminum Hydroxide

The aluminum hydroxide contained in the rubber composition of the present technology is not particularly limited. Examples thereof include conventionally known aluminum hydroxides.

From the perspective of excellent low smoke emission effect, the average particle size of the aluminum hydroxide is preferably not less than 0.5 μm and not greater than 30 μm, more preferably not less than 0.5 μm and not greater than 10 μm, and even more preferably not less than 0.5 μm and not greater than 2.0 μm. In the present technology, the average particle size of aluminum hydroxide was calculated from a particle size distribution curve measured by laser scattering. “Microtrac MT-3300EX” manufactured by Nikkiso Co., Ltd. was used in measurement, and the mode used in calculation of particle size distribution was “HRA mode”.

The method for producing the aluminum hydroxide is not particularly limited. Examples thereof include conventionally known methods.

Examples of commercially available products of aluminum hydroxide include Higilite H-42M (manufactured by Showa Denko K.K.), and the like.

One type of aluminum hydroxide can be used alone or a combination of two or more types can be used.

In the present technology, the content of aluminum hydroxide is preferably from 20 to 45 parts by mass per 100 parts by mass of the rubber components, and from the perspective of exhibiting superior effect of the present technology and excellent flame retardancy and heat aging resistance, the content is preferably from 25 to 35 parts by mass.

When the content of aluminum hydroxide is less than 40 parts by mass per 100 parts by mass of the rubber components, rupture properties and wear resistance are superior.

Furthermore, when the content of aluminum hydroxide is greater than 30 parts by mass per 100 parts by mass of the rubber components, heat aging resistance is excellent.

### Carbon Black

The carbon black contained in the rubber composition of the present technology is not particularly limited.

Examples of the carbon black include furnace blacks such as general purpose furnace (GPF) carbon black, high abrasion furnace (HAF) carbon black, super abrasion furnace (SAF) carbon black, intermediate super abrasion furnace (ISAF) carbon black, fast extruding furnace (FEF) carbon black, semi-reinforcing furnace (SRF) carbon black, and MAF carbon black; and thermal blacks such as fine thermal (FT) carbon black and medium thermal (MT) carbon black.

The method for producing the carbon black is not particularly limited.

One type of carbon black can be used alone or a combination of two or more types can be used.

In the present technology, the content of carbon black is preferably greater than 65 parts by mass per 100 parts by mass of the rubber components, and from the perspective of exhibiting superior effect of the present technology and an excellent balance between wear resistance and processability, the content is preferably from 66 to 90 parts by mass, and more preferably from 66 to 75 parts by mass.

The mass ratio of aluminum hydroxide to carbon black (aluminum hydroxide/carbon black) is preferably from 0.22 to 0.70 and more preferably from 0.3 to 0.5 from the perspective of exhibiting superior effect of the present technology and an excellent balance between wear resistance and flame retardancy.

From the perspective of exhibiting superior effect of the present technology, an example of a preferable aspect of the composition of the present technology is one that further contains silica.

The silica that may be further contained in the rubber composition of the present technology is not particularly limited. Examples include natural silica, molten silica, amorphous silica, hollow silica, fumed silica, and the like.

The method for producing the silica is not particularly limited. Examples include wet methods and dry methods.

One type of silica can be used alone or a combination of two or more types can be used.

The content of silica is preferably from 5 to 25 parts by mass, and more preferably from 10 to 20 parts by mass, per 100 parts by mass of the rubber components from the perspective of exhibiting superior effect of the present technology.

### Other Components

The rubber composition of the present technology may further contain components other than the components described above (other components). Examples of other components include resins; fillers other than carbon black and silica; flame retardants other than aluminum hydroxide; anti-aging agents, antioxidants, anti-corrosion agents, photostabilizers, ultraviolet absorbents, polymerization inhibitors, silane coupling agents, vulcanizing agents, cross-linking agents, organic peroxides, vulcanization accelerators, vulcanization aids, magnesium oxide, zinc oxide, oils, plasticizers, and stearic acid. The content of each of the above components may be selected as appropriate.

### Method for Producing Rubber Composition

The method for producing the rubber composition of the present technology is not particularly limited. An example of the method for producing the rubber composition is a method including kneading the chloroprene rubber, aluminum hydroxide, and a carbon black, and rubbers other than chloroprene rubber, a silica, and other components that can be used as necessary (excluding vulcanizing agents, vulcanization aids, vulcanization accelerators, and zinc oxide) in a Banbury mixer or the like to obtain a mixture, then adding the vulcanizing agents, vulcanization aids, vulcanization accelerators, and zinc oxide to the mixture, and kneading with a kneading roll.

Conditions for vulcanization of the rubber composition of the present technology are not particularly limited. For example, the rubber composition of the present technology may be vulcanized by heating at a temperature of approximately 130° C. to 180° C. for 15 minutes to 200 minutes.

### Application

The rubber composition of the present technology may be used for producing a flame-retardant hose.

### Flame-Retardant Hose

The flame-retardant hose of the present technology is a flame-retardant hose including a rubber layer formed using the rubber composition for a flame-retardant hose of the present technology.

The flame-retardant hose of the present technology has excellent flame retardancy, rupture properties, and wear resistance because it has a rubber layer formed using the rubber composition of the present technology.

The rubber composition for a flame-retardant hose used in the flame-retardant hose of the present technology is not particularly limited as long as it is the rubber composition for a flame-retardant hose of the present technology.

Examples of the rubber layers of the flame-retardant hose of the present technology include an inner side rubber layer and a cover rubber layer. The flame-retardant hose of the present technology includes at least a cover rubber layer, and an example of a preferable aspect is one in which the cover rubber layer is formed using the rubber composition of the present technology.

The flame-retardant hose of the present technology may further include an intermediate rubber layer. The rubber composition that forms the intermediate rubber layer is not particularly limited. Examples thereof include conventionally known methods. The intermediate rubber layer may be formed using the rubber composition of the present technology. The flame-retardant hose of the present technology may include one or a plurality of intermediate rubber layers.

The rubber composition that forms the inner side rubber layer is not particularly limited. Examples thereof include conventionally known rubber compositions. The inner side rubber layer may be formed using the rubber composition of the present technology.

When the flame-retardant hose of the present technology includes a plurality of rubber layers, it may include reinforcing layers between the rubbers layers. Note that when an intermediate rubber layer and a reinforcing layer are adjacent, the adjacent intermediate rubber layer and reinforcing layer are sometimes collectively called an intermediate rubber reinforcement layer. The intermediate rubber reinforcement layer may be one or a plurality of layers.

Here, an example of a preferred embodiment of the flame-retardant hose of the present technology is described below while referencing the attached drawings. However, the present technology is not limited to the attached drawings.

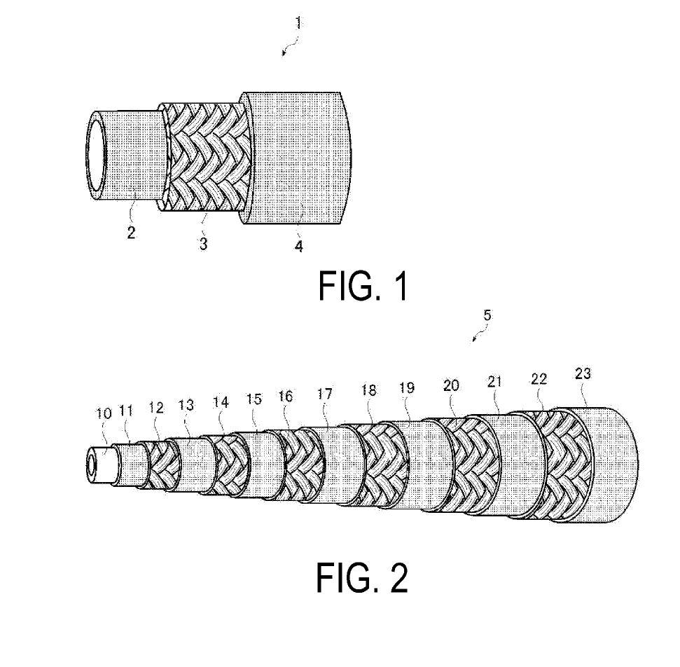

FIG. 1 is a perspective view illustrating a cutaway of each layer of an example of the flame-retardant hose of the present technology.

As illustrated in FIG. 1, a flame-retardant hose 1 includes an inner side rubber layer 2 as an inner tube, and a reinforcing layer 3 and a cover rubber layer 4 as an outer tube on top of the inner side rubber layer 2.

FIG. 2 is a perspective view illustrating a cutaway of each layer of another example of the flame-retardant hose of the present technology.

As illustrated in FIG. 2, a flame-retardant hose 5 is a hose including an inner side rubber layer 10 as the innermost layer, a cover rubber layer 23 as the outermost layer, and intermediate rubber layers 11, 13, 15, 17, 19, and 21 and reinforcing layers 12, 14, 16, 18, 20, and 22 between the inner side rubber layer 10 and the cover rubber layer 23, wherein the intermediate rubber layers and reinforcing layers alternate.

Next, the rubber layers (inner side rubber layer, cover rubber layer, or intermediate rubber layer) and reinforcing layers constituting the flame-retardant hose of the present technology will be described in detail.

### Rubber Layers

The thickness of the inner side rubber layer is preferably from 0.2 to 4.0 mm, and more preferably from 0.4 to 2.5 mm.

The thickness of the cover rubber layer is preferably from 0.2 to 4.0 mm, and more preferably from 0.4 to 2.5 mm.

The thickness of the intermediate rubber layer is preferably from 0.2 to 0.7 mm, and more preferably from 0.3 to 0.5 mm.

### Reinforcing Layers

The reinforcing layers are layers provided from the perspective of maintaining strength. The reinforcing layers may be provided on the outer side of a rubber layer (for example, on the outer side of at least one rubber layer selected from the group consisting of the inner side rubber layer, intermediate rubber layer, and cover rubber layer).

In the present technology, the reinforcing layers may be formed in a blade shape or in a helical shape.

Furthermore, the material that forms the reinforcing layers is not particularly limited, and conventionally known metal wire or various fiber materials (for example, nylon, and polyester) may be used.

### Other Rubber Layers, Resin Layers

The flame-retardant hose of the present technology may further include other rubber layers and resin layers between the rubber layers and reinforcing layers.

The rubber materials that form the other rubber layers are not particularly limited, and may be, for example, the rubbers used in producing the rubber composition of the present technology.

Furthermore, the resin material that forms the resin layers is not particularly limited, and conventionally known polyamide resin, polyester resin, and the like may be used.

### Method for Producing Flame-Retardant Hose

The method for producing the flame-retardant hose of the present technology is not particularly limited, and a conventionally known method may be used.

A specific suitable example is a method wherein an inner side rubber layer, one or a plurality of intermediate rubber reinforcement layers, and a cover rubber layer are laminated in that order on a mandrel, and then this laminate, further covered with a nylon cloth, is submitted to steam vulcanization, oven vulcanization (heat vulcanization), or hot water vulcanization at 140° C. to 190° C. for 30 to 180 minutes to vulcanization bond it.

### Applications of Flame-Retardant Hose

The flame-retardant hose of the present technology may be used as, for example, a hydraulic hose, a hose for transporting refrigerant, and a marine hose.

### EXAMPLES

The present technology is described below in detail using examples but the present technology is not limited to such examples.

### Production of Rubber Composition

Rubber compositions were prepared by blending the components shown in the following Table 1 in the proportions (part by mass) shown in the table. Note that when producing each of the rubber compositions, the components shown in Table 2 below were additionally used as common compounds in the proportions (part by mass) shown in the table.

Specifically, a master batch was obtained by first kneading all of the components shown in Tables 1 and 2 below, except the zinc oxide, the vulcanization accelerator, and the sulfur, for 4 minutes in a (3.4-L) Banbury mixer, and then discharging the kneaded product when the temperature reached 160° C.

Then, the zinc oxide, the vulcanization accelerator, and the sulfur were added to the obtained master batch, and these were kneaded by an open roll to obtain a rubber composition.

### Evaluation

The following evaluations were performed using the rubber compositions produced as described above. The results are shown in Table 1.

### Physical Properties in Normal State

### Test Pieces

Vulcanized rubber sheets having a thickness of 2 mm were produced by vulcanizing each of the rubber compositions produced as described above by applying surface pressure of 3.0 MPa at 148° C. for 45 minutes using a press molding machine. A dumbbell-shaped JIS (Japanese Industrial Standard) No. 3 test piece was punched from each of these sheets, and the test pieces were used in evaluation of physical properties in the normal state (the tensile test described below).

### Tensile Test

Using the test piece described above, a tensile test was performed at a tensile test speed of 500 mm/minute at 23° C. in accordance with JIS K6251:2010, and tensile strength (T_{B}) [MPa] and elongation at break (E_{B}) [%] were measured.

Elongation at Break (E_{B}) after Heat Resistance Testing

The same test pieces as those used for evaluating physical properties in normal state described above were subjected to heat resistance test whereby they were placed in the air at 100° C. for 72 hours. After heat resistance test, tensile test was conducted in the same manner as described above, and elongation at break (E_{B}) [%] after heat resistance test was measured. ΔE_{B}

E_{B} of physical properties in normal state and E_{B} after heat resistance test measured as described above were fitted into the equation below to calculate ΔE_{B}.

ΔE_{B} (%)=[(E_{B} after heat resistance test−E_{B} of physical properties in normal state)/E_{B} of physical properties in normal state]×100

A smaller absolute value of ΔE_{B} (|ΔE_{B}|) calculated as described above indicates better heat aging resistance in the air. ΔE_{B} is shown in Table 1.

### Flame Retardancy

### Evaluation Samples

Each of the rubber compositions produced as described above was press vulcanized in a mold at 148° C. for 45 minutes, and an evaluation sample obtained by cutting a piece measuring 150 mm long, 12.7 mm wide, and 2.5 mm thick from the obtained vulcanized rubber sheet was used in evaluation of flame retardancy (flame extinguishing time and afterglow extinguishing time).

### Flame Retardancy (Flame Extinguishing Time)

Flame retardancy (flame extinguishing time) was evaluated based on the flame retardancy (flame extinguishing time) evaluation of ASTP 5007 of the MSHA standard (U.S. Mine Safety and Health Administration Standard) (version 2012-02-12) using the evaluation samples obtained as described above.

A smaller numeric value of flame extinguishing time (unit: seconds) indicates superior flame retardancy.

### Flame Retardancy (Afterglow Extinguishing Time)

Flame retardancy (afterglow extinguishing time) was evaluated based on the flame retardancy (afterglow extinguishing time) evaluation of ASTP 5007 of the MSHA standard (version 2012-02-12) using the evaluation samples obtained as described above.

A smaller numeric value of afterglow extinguishing time (unit: seconds) indicates superior flame retardancy.

### Wear Resistance (Akron Wear Test)

### Test Pieces

In evaluation of wear resistance, disk shaped test pieces having a diameter of 63.5±0.5 mm, thickness of 12.7±0.5 mm, and a center hole measuring 12.7±0.1 mm were produced by vulcanizing each of the rubber compositions produced as described above by applying surface pressure of 3.0 MPa at 148° C. for 45 minutes using a press molding machine.

### Wear Test

Wear resistance (Akron wear test) was evaluated in accordance with JIS K 6264-2:2005 (Akron wear test method A, applied force 27 N, tilt angle 15 degrees, number of test rotations 1000 times), using the test pieces obtained as described above.

A smaller wear amount (unit: mm³) indicates better wear resistance.

TABLE 1

| | Comparative | Example | Example | Example | Example |
|---|---|---|---|---|---|
| | Example 1 | 1 | 2 | 3 | 4 |
| CR | 85 | 85 | 85 | 85 | 85 |
| SBR | 15 | 15 | 15 | 15 | 15 |
| Aluminum hydroxide | 15 | 20 | 25 | 30 | 40 |
| Carbon black 1 | 45 | 43 | 43 | 45 | 43 |
| Carbon black 2 | 25 | 25 | 24 | 24 | 24 |
| Aluminum hydroxide/ | 0.21 | 0.29 | 0.37 | 0.43 | 0.60 |
| carbon black | | | | | |
| Silica | 0 | 0 | 0 | 0 | 0 |
| Physical properties in normal | 12.4 | 12.1 | 11.8 | 11.5 | 10.9 |
| state T_{B} (MPa) | | | | | |
| Physical properties in normal | 370 | 360 | 360 | 360 | 350 |
| state E_{B} (%) | | | | | |
| E_{B} after heat resistance test (%) | 310 | 300 | 300 | 300 | 295 |
| ΔE_{B} (%) | −16 | −17 | −17 | −17 | −16 |
| Flame retardancy Flame | 10 | 10 | 10 | 10 | 10 |
| extinguishing time (seconds) | | | | | |
| Flame retardancy Afterglow | 160 | 0 | 0 | 0 | 0 |
| extinguishing time (seconds) | | | | | |
| Wear resistance (mm³) | 160 | 180 | 195 | 210 | 245 |
| | Comparative | Example | Example | Example | Example |
| | Example 2 | 5 | 6 | 7 | 8 |
| CR | 85 | 85 | 85 | 85 | 85 |
| SBR | 15 | 15 | 15 | 15 | 15 |
| Aluminum hydroxide | 50 | 20 | 25 | 25 | 25 |
| Carbon black 1 | 45 | 43 | 66 | 0 | 0 |
| Carbon black 2 | 24 | 24 | 0 | 74 | 90 |
| Aluminum hydroxide/ | 0.72 | 0.30 | 0.38 | 0.34 | 0.28 |
| carbon black | | | | | |
| Silica | 0 | 15 | 0 | 0 | 0 |
| Physical properties in normal | 10.2 | 12.1 | 12.2 | 11.5 | 12.1 |
| state T_{B} (MPa) | | | | | |
| Physical properties in normal | 340 | 370 | 350 | 360 | 310 |
| state E_{B} (%) | | | | | |
| E_{B} after heat resistance test (%) | 285 | 300 | 290 | 310 | 265 |
| ΔE_{B} (%) | −16 | −19 | −17 | −14 | −15 |
| Flame retardancy Flame | 10 | 10 | 10 | 10 | 10 |
| extinguishing time (seconds) | | | | | |
| Flame retardancy Afterglow | 0 | 0 | 0 | 0 | 0 |
| extinguishing time (seconds) | | | | | |
| Wear resistance (mm³) | 280 | 190 | 190 | 195 | 180 |

Details of the components shown in Table 1 are as follows.
CR: trade name: Denka Chloroprene S-41 (manufactured by Denki Kagaku Kogyo K.K.)
SBR: Styrene-butadiene rubber: trade name: Nipol 1502 (manufactured by Zeon Corporation), weight average molecular weight 500000, emulsion - polymerized SBR
Aluminum hydroxide: trade name: Higilite H-42M (manufactured by Showa Denko K.K.), average particle size from 0.8 to 1.2 μm
Carbon black 1: FEF: trade name: Niteron #10N (manufactured by NSCC Carbon Co. Ltd.)
Carbon black 2: GPF: trade name: Niteron #GN (manufactured by NSCC Carbon Co. Ltd.)
Silica: trade name: Nipsil AQ (manufactured by Tosoh Silica Corporation)

TABLE 2

| | |
|---|---|
| Magnesium oxide | 4.0 |
| Stearic acid | 2.0 |
| Process oil | 10 |
| Aroma oil | 20 |
| Sulfur | 0.5 |
| Zinc oxide | 5.0 |
| Vulcanization accelerator TS | 1.0 |
| Vulcanization accelerator D-G | 1.0 |

Details of the components shown in Table 2 are as follows.
Magnesium oxide: trade name: Kyowamag 150 (manufactured by Kyowa Chemical Industry Co., Ltd.)
Stearic acid: trade name: Industrial Stearic Acid N (manufactured by Chiba Fatty Acid Co., Ltd.)
Process oil: trade name: Komorex H22 (manufactured by JX Nippon Oil & Energy Corporation)
Aroma oil; trade name: A/O MIX 2010 (manufactured by Sankyo Yuka Kogyo K.K.)
Sulfur: trade name: Oil-Treated Sulfur (manufactured by Hosoi Chemical Industry Co., Ltd.)
Zinc oxide: trade name: Zinc Oxide III (manufactured by Seido Chemical Industry Co., Ltd.)
Vulcanization accelerator TS: trade name: Sanceler TS-G (manufactured by Sanshin Chemical Industry Co., Ltd.)
Vulcanization accelerator D-G: trade name: Sanceler D-G (manufactured by Sanshin Chemical Industry Co., Ltd.)

As is clear from the results shown in Table 1, Comparative Example 1, in which the content of aluminum hydroxide was smaller than the predetermined value, had lower flame retardancy.

Comparative Example 2, in which the content of aluminum hydroxide was greater than the predetermined value, had low rupture properties and wear resistance.

In contrast, it was ascertained that the desired effect is obtained with the rubber compositions of the present technology.

When Examples 7 and 8 were compared in regard to carbon black content, when the carbon black content was not greater than 75 parts by mass per 100 parts by mass of rubber components (Example 7), elongation at break was superior to when the content was greater than 75 parts by mass (Example 8).

When Examples 1 to 3 and 5 to 7 were compared with Example 4 in regard to aluminum hydroxide content, it was found that when the aluminum hydroxide content was less than 40 parts by mass, rupture properties and wear resistance were superior.

When Examples 3 and 4 were compared in regard to aluminum hydroxide content, it was found that when the aluminum hydroxide content was greater than 30 parts by mass, heat aging resistance was excellent.

When Examples 1 and 5 were compared in regard to the presence or absence of silica, Example 5, which contained silica, had superior elongation at break compared to Example 1, which did not contain silica.

1. A rubber composition for a flame-retardant hose, the composition comprising from 20 to 45 parts by mass of aluminum hydroxide and greater than 65 parts by mass of a carbon black, per 100 parts by mass of a rubber component containing at least chloroprene rubber.

2. The rubber composition for a flame-retardant hose according to claim 1, wherein the rubber component further comprises a diene rubber other than the chloroprene rubber.

3. The rubber composition for a flame-retardant hose according to claim 2, wherein the diene rubber is styrene-butadiene rubber.

4. The rubber composition for a flame-retardant hose according to claim 1, wherein
a content of the chloroprene rubber is not less than 70 parts by mass per 100 parts by mass of the rubber component.

5. The rubber composition for a flame-retardant hose according to claim 1, wherein
a content of the carbon black is from 66 to 90 parts by mass per 100 parts by mass of the rubber component.

6. The rubber composition for a flame-retardant hose according to claim 1, further comprising a silica, wherein a content of the silica is from 5 to 25 parts by mass per 100 parts by mass of the rubber component.

7. A flame-retardant hose comprising a rubber layer formed using the rubber composition for a flame-retardant hose described in claim 1.

8. The rubber composition for a flame-retardant hose according to claim 2, wherein a content of the chloroprene rubber is not less than 70 parts by mass per 100 parts by mass of the rubber component.

9. The rubber composition for a flame-retardant hose according to claim 3, wherein a content of the chloroprene rubber is not less than 70 parts by mass per 100 parts by mass of the rubber component.

10. The rubber composition for a flame-retardant hose according to claim 2, wherein a content of the carbon black is from 66 to 90 parts by mass per 100 parts by mass of the rubber component.

11. The rubber composition for a flame-retardant hose according to claim 3, wherein a content of the carbon black is from 66 to 90 parts by mass per 100 parts by mass of the rubber component.

12. The rubber composition for a flame-retardant hose according to claim 4, wherein a content of the carbon black is from 66 to 90 parts by mass per 100 parts by mass of the rubber component.

13. The rubber composition for a flame-retardant hose according to claim 2, further comprising a silica, wherein a content of the silica is from 5 to 25 parts by mass per 100 parts by mass of the rubber component.

14. The rubber composition for a flame-retardant hose according to claim 3, further comprising a silica, wherein a content of the silica is from 5 to 25 parts by mass per 100 parts by mass of the rubber component.

15. The rubber composition for a flame-retardant hose according to claim 4, further comprising a silica, wherein a content of the silica is from 5 to 25 parts by mass per 100 parts by mass of the rubber component.

16. The rubber composition for a flame-retardant hose according to claim 5, further comprising a silica, wherein a content of the silica is from 5 to 25 parts by mass per 100 parts by mass of the rubber component.
